(19) United States
(12) Patent Application Publication
(10) Pub. No.: US 2009/0244549 A1
(43) Pub. Date: Oct. 1, 2009

(54) Contact Displacement Meter

(75) Inventor: Tomikazu Sakaguchi, Osaka (JP)

Correspondence Address: KILYK & BOWERSOX, P.L.L.C., 400 HOLIDAY COURT, SUITE 102, WARRENTON, VA, 20186, US

(73) Assignee: Keyence Corporation, Osaka (JP)

(21) Appl. No.: 12/392,196

(22) Filed: Feb. 25, 2009

(30) Foreign Application Priority Data
Mar. 25, 2008 (JP) 2008-079242

(51) Int. Cl. G01B 11/14

(52) U.S. Cl. 356/614

(57) ABSTRACT

There is provided a contact displacement meter in which the size of the housing can be miniaturized as much as possible without lowering the measurement accuracy of a displacement. Light emitted by a light emitting element is converted to parallel light by a lens, and then is deflected to a predetermined direction and converted to wide-width parallel light by a prism. The displacement of a contact attached with one of a plate-shaped scale member and a linear sensor is calculated from a projection position of a reference pattern and the unique information obtained based on a plurality of received light signals of the linear sensor.

### CROSS-REFERENCE TO RELATED APPLICATIONS

The present application claims foreign priority based on Japanese Patent Application No. 2008-079242, filed Mar. 25, 2008, the contents of which is incorporated herein by reference.

### BACKGROUND OF THE INVENTION

1. Field of the Invention

The present invention relates to a contact displacement meter that incorporates an image sensor such as a CMOS and a CCD and measures a displacement of a contact with respect to a housing by reading a relative displacement of an optical scale with use of the image sensor.

2. Description of the Related Art

In a conventional optical transmissive linear sensor, an optical lattice is arranged on the contact that can move in a certain direction, where the transmitted light quantity fluctuates depending on whether or not it overlaps the grating of a fixed scale. The displacement can be measured by calculating the movement amount of the contact according to the fluctuating light quantity.

For instance, Japanese Unexamined Patent Publication No. 2000-241115 discloses an absolute position length measurement device for detecting an absolute position pattern arranged at every constant interval to accurately specify the reference position for calculating the displacement. However, to perform an accurate measurement the light projected on an optical grating needs to be parallel light having a predetermined width along the arraying direction of the pattern of the optical grating and having a constant light quantity distribution. In order to obtain a constant light quantity distribution, only the light near the optical axis of the light from the light emitter needs to be used, and the light needs to have a predetermined width along the arraying direction of the pattern of the optical grating, and thus the distance between the light emitting element and the lens needs to be spaced apart by a predetermined amount, whereby the optical part becomes relatively large and the entire length measurement device becomes difficult to miniaturize.

Japanese Unexamined Patent Publication NO. 2003-106872, on the other hand, discloses a linear sensor miniaturized by miniaturizing the light source without using the fixed scale. In Japanese Unexamined Patent Publication NO. 2003-106872, the light emitted from an LED, or a single light source, is converted to wide-width parallel light by a lens, and such parallel light is supplied to the linear sensor, so that high measurement accuracy is maintained while achieving miniaturization.

However, when generating the parallel light with the lens as in Japanese Unexamined Patent Publication NO. 2003-106872, the light quantity tends to reduce at the peripheral edge part of the lens compared to the central part, and accurate measurement becomes difficult to carry out. Furthermore, light that is not used for measurement irradiated on regions other than the pattern of the optical grating is in great amount, where problems such as enlargement of the light emitting element and heat generation arise in obtaining a sufficient light receiving quantity, and miniaturization of the linear sensor has limits.

### SUMMARY OF THE INVENTION

In view of the above situations, it is an object of the present invention to provide a contact displacement meter in which the size of the housing can be miniaturized as much as possible without lowering the measurement accuracy of the displacement.

In order to achieve the above object, according to a first invention, a contact displacement meter includes: a light emitting element; a lens that converts light emitted by the light emitting element to parallel light; a prism that deflects the parallel light converted by the lens to a predetermined direction, and converts to wide-width parallel light; a plate-shaped scale member formed with a predetermined pattern including a plurality of reference patterns and unique information on each of the reference patterns in a direction substantially orthogonal to the predetermined direction as a combination of a light passing region for passing light and a light shielding region for shielding light, and arranged in an irradiation range of the converted parallel light; a linear sensor including a plurality of light receiving elements that are arrayed at substantially equal intervals along the direction substantially orthogonal to the predetermined direction and that receive passed light of the wide-width parallel light converted by the prism irradiated on the scale member; a housing that accommodates the light emitting element, the lens, the prism, the scale member, and the linear sensor, and that is fixed with one of the scale member and the linear sensor; a contact that is fixed with another one of the scale member and the linear sensor, and that is attached to be movable in the direction substantially orthogonal to the predetermined direction with respect to the housing; and a calculation unit that obtains a projection position of the reference pattern on the linear sensor and the unique information on the reference pattern based on a received light signal received by the plurality of light receiving elements in the linear sensor, and that calculates a displacement of the contact based on the projection position and the unique information.

In the first invention, after the light emitted by the light emitting element is converted to parallel light by a relatively small lens, the light is converted to a wide-width parallel through a prism and supplied to a linear sensor. Thus, the lens does not need to be enlarged, and the direction of the lens is not fixed, and thus the degree of freedom in the arrangement of the light emitting element, the lens, and the like increases, and the housing can be miniaturized as a whole.

According to a second invention, in the contact displacement meter of the first invention, the light emitting element and the lens are incorporated in an integrated element holder in a substantially square shape, and the element holder has a rotational mechanism that rotates with respect to the housing with a corner closest to the prism as a center of rotation.

In the second invention, the substantially square element holder integrally incorporating the light emitting element and the lens is rotatably attached with the corner closest to the prism as the center of rotation. The angle adjustment of the element holder is carried out by changing the interposing number of thin plate materials, where the change in angle involved in the change in the interposing number can be fined by increasing the turning radius to the thin plate interposing position.

According to a third invention, in the contact displacement meter of the first or the second invention, the contact is arranged with a cantilever member that extends in a direction substantially parallel to the predetermined direction and has a distal end in a pin-shape, and a fixed part having a long groove along the direction substantially orthogonal to the predetermined direction in which the pin-shaped distal end of the cantilever member is movable is fixed to the housing.

In the third invention, the pin-shaped cantilever member is arranged on the contact, which cantilever member is fitted with the fixed part including the long groove along the movement direction of the contact. Thus, although the cantilever member also moves along the groove with the movement of the contact, the cantilever member cannot rotate with the center axis of the contact as the axis, and thus the contact does not rotate. Therefore, the direction of the scale member is always maintained constant, and the displacement measurement accuracy can be enhanced.

According to a fourth invention, in the contact displacement meter of the third invention, the cantilever member is a quenched stainless steel or a quenched iron steel, and the fixed part is polyphenylsulfide including glass fiber.

In the fourth invention, the cantilever member is formed by quenched stainless steel or quenched iron steel, and the fixed part is formed by polyphenylsulfide including glass fiber, so that abrasion powder does not produce at the groove and long-time use can be withstood even in a case where the cantilever member moves along the groove with the movement of the contact.

According to a fifth invention, in the contact displacement meter of any one of the first to the fourth inventions, the housing includes a void wall having a shape of reflecting light reflected at an incident surface of the prism out of the parallel light from the lens to a direction in which the light does not re-enter the prism.

In the fifth invention, the void wall having a shape of reflecting the light reflected at the incident surface of the prism to a direction in which the light does not re-enter the prism is arranged, so that the extent the light reflected by the incident surface of the prism re-enters the prism is reduced, and interference by scattered light etc. is less likely to occur. Therefore, mistaken detection at the linear sensor can be avoided in advance, and the displacement can be accurately measured.

According to a sixth invention, in the contact displacement meter of any one of the first to the fifth inventions, the housing is sealed such that air inside does not leak outside, a connector portion that is connected with an external wiring is arranged, and the connector portion has a plurality of connection pins, and a hole passed through into the housing so that air enters and exits through the hole.

In the sixth invention, the hole passed through into the housing is formed at the connector portion connected with the external wiring, so that the air inside is discharged to the outside from the hole when the contact moves, whereby the air resistance with respect to the movement of the contact can be reduced and a more precise displacement measurement can be performed.

According to the above configuration, the lens does not need to be enlarged and the direction of the lens is not fixed, and thus the degree of freedom in the arrangement of the light emitting element, the lens, and the like increases and the housing can be miniaturized as a whole. Since the element holder can rotate with the corner closest to the prism as the center of rotation, the turning radius becomes larger than when the central part of the element holder is the center of rotation. The rotational moment becomes about twice when rotating the element holder with the same force, and thus the angle adjustment of the element holder is more precisely performed, and the displacement can be accurately measured even when miniaturized.

Furthermore, although the cantilever member also moves along the groove with the movement of the contact, the cantilever member cannot rotate with the center axis of the contact as the axis, and thus the contact does not rotate. Therefore, the direction of the scale member is always maintained constant, and the displacement measurement accuracy can be enhanced.

In addition, with the arrangement of the void wall having a shape of reflecting the light reflected at the incident surface of the prism to a direction different from the prism direction, the extent the light reflected at the incident surface of the prism re-enters the prism is reduced, and interference by the scattered light etc. is less likely to occur. Therefore, mistaken detection at the linear sensor can be avoided in advance, and the displacement can be accurately measured.

As the air inside is discharged to the outside from the hole when the contact moves, the air resistance with respect to the movement of the contact can be reduced, and a more precise displacement measurement can be performed.

### BRIEF DESCRIPTION OF THE DRAWINGS

FIG. 1 is a perspective view showing an outer appearance of a contact displacement meter according to First Embodiment of the present invention;

FIG. 2 is a plan view showing arrangement of the internal components in a housing of the contact displacement meter according to First Embodiment of the present invention;

FIG. 3 is a plan view showing arrangement of the internal components in the housing of the contact displacement meter according to First Embodiment of the present invention;

FIG. 4 is a schematic view showing an outline of an optical mechanism of the contact displacement meter according to First Embodiment of the present invention;

FIG. 5 is a cross-sectional view of a plane orthogonal to the movement direction of a contact, showing the arrangement of the internal components in the housing of the contact displacement meter according to First Embodiment of the present invention;

FIG. 6 is a perspective view showing a configuration of a cantilever member and a fixed part of the contact displacement meter according to First Embodiment of the present invention;

FIG. 7 is a plan view showing an arrangement of the vicinity of the optical mechanism of a contact displacement meter according to Second Embodiment of the present invention;

FIGS. 8A and 8B are schematic views for comparing the rotational moment of an element holder;

FIG. 9 is a plan view showing the shape of a void wall arranged in the vicinity of the prism of the contact displacement meter according to Second Embodiment of the present invention; and

FIG. 10 is a perspective view including a connector portion of a contact displacement meter according to Third Embodiment of the present invention.

### DETAILED DESCRIPTION OF THE PREFERRED EMBODIMENTS

Embodiments of the present invention will be described in detail below with reference to the drawings. Same or similar symbols are denoted for elements having the same or similar configurations or functions throughout the drawings referenced in the description of each of the embodiments, and detailed description thereof will not be repeated.

### First Embodiment

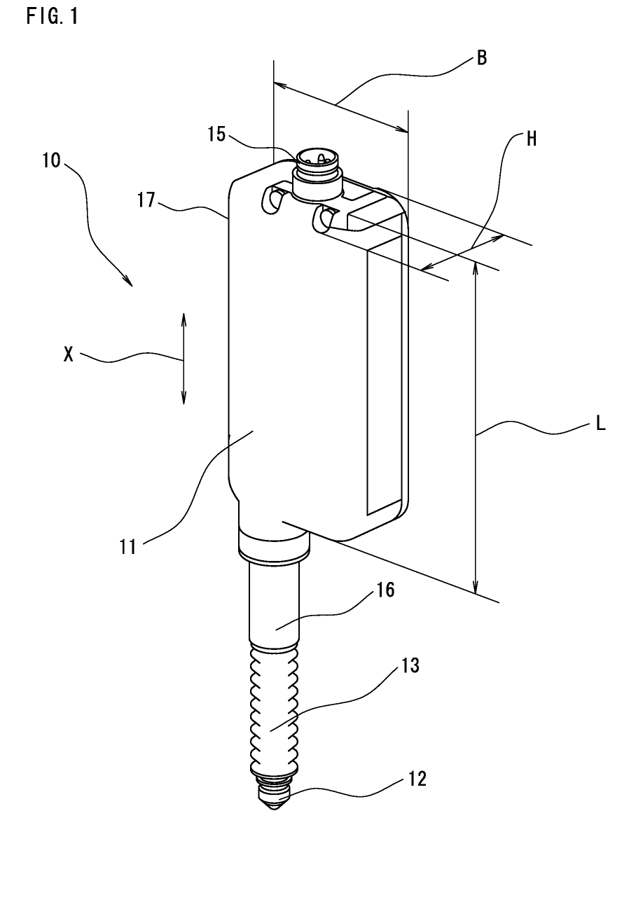

FIG. 1 is a perspective view showing an outer appearance of a contact displacement meter according to First Embodiment of the present invention. A contact displacement meter 10 according to First Embodiment includes, in the interior of a housing 11, a contact 12 relatively movable in one direction (X direction shown in FIG. 1) with the housing 11, and measures the relative displacement in the X direction of the contact 12 with respect to the housing 11. An accordion cover 13 is arranged between the contact 12 and the housing 11 to prevent dust, dirt, and the like from entering the moving portion. The housing 11 has a substantially rectangular solid shape, which size L×W×H is about 60 mm×30 mm×15 mm.

A substantially cylindrical contact holder 16 is formed on the outer side of the housing 11 along the X direction from a surface orthogonal to the X direction of the housing 11. As shown in FIG. 1, the contact holder 16 is formed at a position deviated towards a first side surface 17. The contact 12 is attached to the contact holder 16 of the housing 11 in a freely movable manner in the X direction by way of a ball bearing, and the like. An elastic body such as a spring (not shown) for biasing the contact 12 in the projecting direction is arranged between the contact 12 and the housing 11.

A connector portion 15 is arranged on the surface of the housing 11 facing opposite to the surface formed with the contact holder 16. The connector portion 15 is electrically connected to an external electronic device by way of an external wiring (not shown). The external wiring is removably connected with the housing 11 by the connector portion 15 arranged on the side opposite to the side arranged with the contact 12. The external wiring includes a connector formed in a straight-shape or in an L-shape corresponding to the connector portion 15, and a cable connected to the cable, where the connector formed in the straight-shape or in the L-shape is screw-fit and fixed to the connector portion 15.

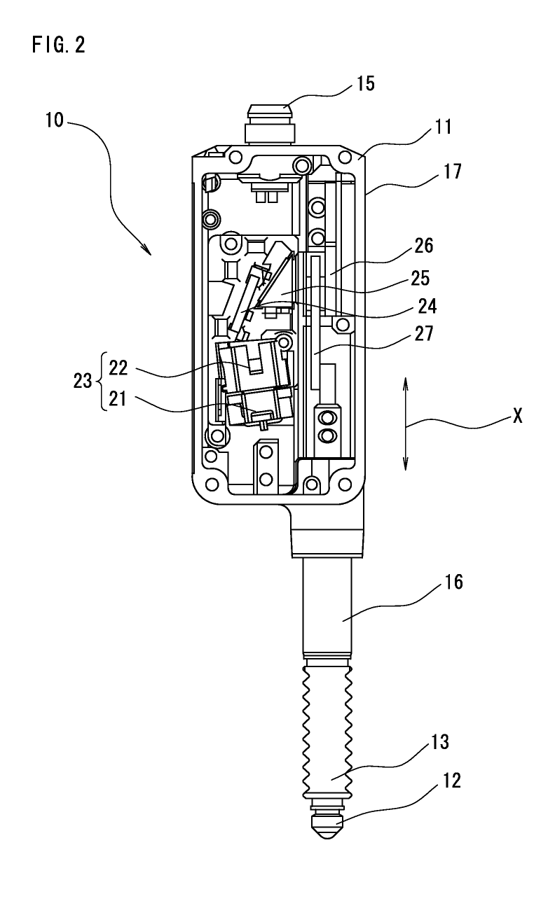

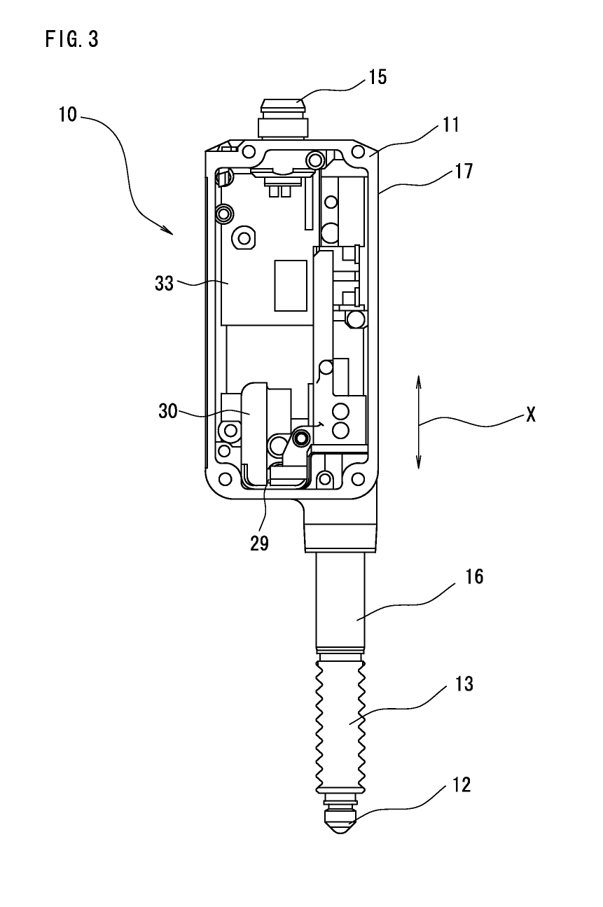

FIGS. 2 and 3 are plan views each showing an arrangement of internal components in the housing 11 of the contact displacement meter 10 according to First Embodiment of the present invention. FIG. 2 is a plan view showing the component arrangement at the lower stage with the optical mechanism including a light emitting element as the center, and FIG. 3 is a plan view showing the component arrangement at the upper stage with the control substrate mounted with CPU, memory, and the like installed. That is, FIG. 2 is a view in which the upper stage side is omitted, and FIG. 3 is a view in which the lower stage side is omitted.

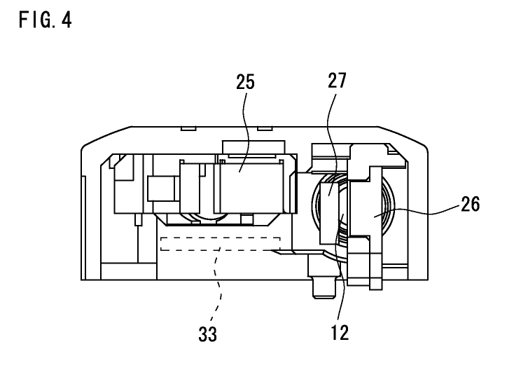

FIG. 4 is a cross-sectional view of a plane orthogonal to the movement direction of the contact 12 in FIG. 2, showing the arrangement of the internal components in the housing 11 of the contact displacement meter 10 according to First Embodiment of the present invention. FIG. 4 is shown turned upside down, and thus the near side with respect to the plane of drawing is the upper stage and the far side is the lower stage, where the optical mechanism configured by a prism 25, and the like is arranged on the lower stage side of the housing 11, and the control substrate 33 is arranged in an open are on the upper stage side. Thus, the height H of the housing 11 is made to a minimum by partially overlapping the optical mechanism and the control substrate 33.

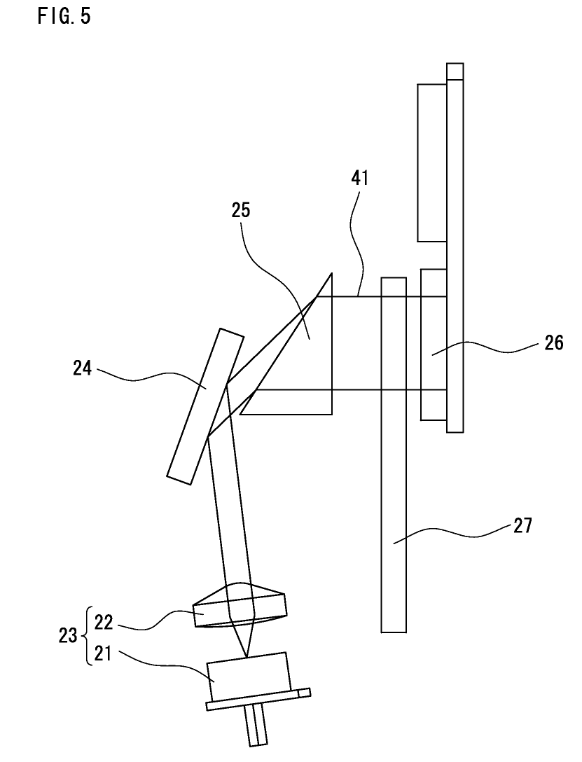

FIG. 5 is a schematic view showing an outline of the optical mechanism of the contact displacement meter 10 according to First Embodiment of the present invention. The contact displacement meter 10 according to First Embodiment shown in FIG. 2 includes an element holder 23 for holding a light emitting element 21 such as a laser and an LED, and a lens 22 for converting the light emitted by the light emitting element 21 to parallel light, where the parallel light converted by the lens 22 is guided to the prism 25 via a mirror 24, as shown by an optical path 41 of FIG. 4. The light guided to the prism 25 is deflected to a predetermined direction, and guided to a line sensor (linear sensor) 26, in which a plurality of light receiving elements such as a CMOS and a CCD are arrayed at a predetermined interval, as wide-width parallel light.

A plate-shaped scale member 27 attached to the moving contact 12 is arranged between the prism 25 and the line sensor 26 so as to correspond to the optical path 41. The scale member 27 is attached with a predetermined pattern including a plurality of reference patterns and unique information for each reference pattern as a combination of a light passing region for passing light and a light shielding region for shielding light in a direction substantially orthogonal to the wide-width parallel light from the prism 25. That is, the predetermined pattern including the plurality of reference patterns and the unique information on each of the reference patterns of the scale member 27 is formed along the X direction, which is the movable direction of the contact 12, and the parallel light projected from the prism 25 towards the scale member 27 has a wide-width in the X direction and has optical axis thereof orthogonal to the X direction, which is the movable direction of the contact 12.

The plurality of light emitting elements configuring the line sensor 26 is arrayed along the X direction, which is the movable direction of the contact 12. The plurality of light receiving elements of the line sensor 26 receive the passed light of the wide-width parallel light irradiated on the scale member 27 and converted by the prism 25, and are arrayed such that the interval of each adjacent light receiving element becomes a substantially equal interval. The line sensor 26 outputs an electric signal obtained by photoelectric converting the received light pattern of the light passing region and the light shielding region to the control substrate (calculation unit) 33 shown in FIG. 3.

As shown in FIG. 2, the scale member 27 is arranged offset to the central side of the housing 11 from the center axis (axis along the movable direction) of the contact 12. That is, the scale member 27 is offset to the direction of moving away from the first side surface 17. The line sensor 26 is arranged in a space formed by the offset of the scale member 27. That is, the line sensor 26 is arranged along the first side surface 17 in the vicinity of the first side surface 17.

The scale member 27 may not be attached to the contact 12, and the scale member 27 may be securely attached to the housing 11 and the line sensor 26 may be attached to the contact 12. In either case, the electric signal corresponding to the relative movement of the contact 12 with respect to the housing 11 is obtained from the linear sensor 26 with the configuration in which the relative movement of the contact 12 with respect to the housing 11 can be reflected as the relative movement of the scale member 27 and the line sensor 26.

The control substrate 33 shown in FIG. 3 is mounted with CPU, memory, and the like, where the projection position on the line sensor 26 of the reference pattern and the unique information on the reference pattern are obtained based on the electric signal output from the line sensor 26, and the displacement of the contact 12 is calculated based on the projection position and the unique information. The control substrate 33 is arranged overlapping at least part of the optical mechanism including the light emitting element 21, the lens 22, and the prism 25 in the up and down direction. That is, the optical mechanism including the light emitting element 21, the lens 22, and the prism 25 is arranged on the lower stage, and the control substrate 33 is arranged on the upper stage. The information related to the calculated displacement is transmitted to the external device via the eternal wiring connected to the connector portion 15.

In a case where the transmitted information related to the displacement is an analog voltage output corresponding to the displacement, the external device is an analog controller, a PLC having an AD conversion function, and the like; and in a case where the transmitted information related to the displacement is represented by a uniquely arranged signal, the external device is a dedicated controller for displaying the displacement transmitted from the contact displacement meter, setting the threshold value with respect to the displacement, or outputting a determination output on whether or not the displacement exceeds the set threshold value.

The optical mechanism of the contact displacement meter will be described with reference to FIG. 5. The LED, which is the light emitting element 21, projects pulse light of a predetermined cycle at a predetermined time width. Of the light projected from the LED, the light in a range assumed as substantially uniform light is directed towards the lens 22, and the other light is shielded by the light shielding body (not shown). The light in the range assumed as substantially uniform light is the diffused light, and such diffused light is converted to parallel light by the lens 22.

The light converted to the parallel light by the lens 22 is directed to a direction along the movable direction of the contact 12, and more specifically, is directed in a manner tilted to a direction of slightly moving away from the contact 12 from the direction along the movable direction. The light converted to the parallel light by the lens 22 is reflected by a mirror 24, and entered to the prism 25. More specifically, the light converted to the parallel light by the lens 22 is reflected at the portion closest to the prism 25 on the mirror 24. The parallel light passes between the mirror 24 and the prism 25 while being reflected at the closest portion of the mirror 24 and the prism 25, so that the mirror 24 can be arranged proximate to the prism 25.

The prism 25 includes a first plane inclined with respect to the movable direction of the contact 12 and a second plane substantially parallel to the movable direction of the contact 12. The parallel light entered to the first plane of the prism 25 exits from the second plane, and as a result, the parallel light entered to the prism 25 is converted to the parallel light, which width is extended in the movable direction of the contact 12, and which is directed to the direction orthogonal to the movable direction of the contact 12, thereby forming the optical path 41.

The scale member 27 connected to the contact 12 is arranged on the optical path 41. The scale member 27 is formed, in the movable direction of the contact 12, with a predetermined pattern including a plurality of reference patterns and unique information for each reference pattern, and a lattice region in which the light passing region and the light shielding region at substantially equal intervals are alternately arrayed at a predetermined array pitch between each predetermined patterns along the movable direction of the contact 12. When the parallel light is irradiated on the lattice region in which the light passing region and the light shielding region are alternately arrayed at a predetermined array pitch, the parallel light passed through the lattice region generates strong and weak light intensity distribution (degree of correlation with the pattern formed in the lattice region) corresponding to the distance from the lattice region due to the influence of diffraction.

At the position that is called as the Fourier image plane and is away from the lattice region 21 by a predetermined distance, there is formed a light image corresponding to the pattern formed on the lattice region 21 having a large light intensity amplitude. The Fourier image plane is formed at a distance expressed as

$$R = n \frac{{d}^{2}}{λ} ( n = 1 , 2 , … )$$

where R is the distance from the lattice region 21, d is the pitch between the adjacent light passing regions, and λ is the wavelength of the parallel light. The line sensor 13 is arranged in correspondence to the position to be formed with the Fourier image plane with respect to the lattice region 21 formed on the movement scale 16.

The contact displacement meter according to First Embodiment is thus formed as the optical mechanism configured by the light emitting element 21, the lens 22, the mirror 24, and the prism 25, so that the total distance of the optical path 41 of the light emitted from the light emitting element 21 can be reduced, the light that becomes a waste when extending the width of the light can be reduced, that is, the light shielded as unnecessary light or light that is not used for detection can be reduced, whereby the light emitting element 21 having high light emission intensity does not need to be selected, and the entire volume can be reduced.

The light has been converted to the parallel light with one lens in the prior art, but it is difficult to convert the light to accurate parallel light as the distortion becomes larger towards the peripheral edge of the lens, and the light in the vicinity of the central part of a large aperture lens is used. In a case where the aperture of the lens is large, sufficient volume for accommodation is required, and thus miniaturization of the housing 11 is difficult. Furthermore, influence of surface roughness is more susceptible, and the interference light tends to easily generate.

In First Embodiment, the light is converted to the wide-width parallel light by the prism 25 instead of being directly converted to the wide-width parallel light by the lens 22. Thus, the large aperture lens does not need to be used for the lens 22, and the volume of the housing 11 to be accommodated can further reduced. Therefore, according to First Embodiment, the housing 11 can be made small as possible, and a compact contact displacement meter can be obtained.

The contact 12 has a rod shape, and thus a rotational movement having the movement direction as the center axis may occur when moving in one direction with respect to the housing 11. When the rotational movement occurs at the contact 12, the angle of the scale member 27 or the line sensor 26 attached to the contact 12 with respect to the parallel light may fluctuate, and the displacement may not be accurately measured.

In order to solve such a problem, a cantilever member 29 extending in a direction substantially orthogonal to the movement direction and having a distal end of a pin shape is arranged on the contact 12, as shown in FIG. 3, in the contact displacement meter 10 according to First Embodiment. The pin-shaped distal end of the cantilever member 29 is fitted into a fixed part 30 having a long groove arranged along the movement direction of the contact 12.

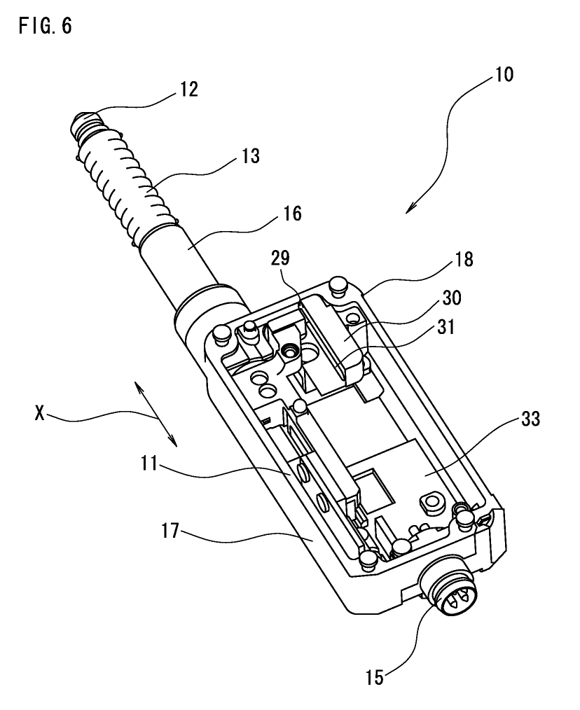

FIG. 6 is a perspective view showing a configuration of the cantilever member 29 and the fixed part 30 of the contact displacement meter 10 according to First Embodiment of the present invention. The cantilever member 29 is fixed to the contact 12 so as to be arranged on the upper stage of the housing 11. The cantilever member 29 is preferably slidably connected to the fixed part 40 at a position spaced apart from the contact 12 as much as possible to oppose the rotational moment with respect to the contact 12. Therefore, the fixed part 30 is arranged on the second side surface 18 opposite to the first side surface 17.

A space corresponding to the movement of the cantilever member 29 needs to be formed in the housing 11 to enable the cantilever member 29 to move in the housing 11 with the movement of the contact 12. The fixed part 30 is arranged on the side opposite to the position to be formed with the control substrate 33 so that the device to be incorporated in the housing 11 is not divided by such a space. That is, the fixed part 30 is fixed on the upper stage side of the housing 11 at the position on the opposite side of the control substrate 33, and the groove 31 is also formed on the upper stage side of the housing 11.

Furthermore, the fixed part 30 may be arranged to overlap at least one part of the optical mechanism including the light emitting element 21, the lens 22, and the prism 25 in the up and down direction, and similarly, the space corresponding to the movement of the cantilever member 29 may be arranged to overlap at least one part of the optical mechanism including the light emitting element 21, the lens 22, and the prism 25 in the up and down direction. In other words, the interior of the housing 11 is formed to a layer configuration of plural stages, where the optical mechanism including the light emitting element 21, the lens 22, and the prism 25 is arranged at the lower stage, and the control substrate 33, the cantilever member 29, and the fixed part 30 are arranged at the upper stage. The contact 12 and the fixed part 30 have shapes that can be fitted to the housing 11, and the groove 31 capable of regulating the movement of the pin-shaped distal end of the cantilever member 29 only to the movement direction of the contact 12 is arranged. The groove 31 has a width to which the pin-shaped distal end of the cantilever member 29 can be fitted, and is extended in the movement direction of the contact 12.

Therefore, the cantilever member 29 also moves along the groove 31 with the movement of the contact 12 by arranging the pin-shaped cantilever member 29 in the contact 12 and fitting the same into to the long groove 31 along the movement direction of the contact 12. The contact 12 cannot rotate with the movement direction as the center axis even in a case where the rotational moment is applied to the contact 12 since the cantilever member 29 contacts the groove 31. Therefore, even in a case where the contact 12 is moved, the contact 12 does not rotate, the direction of the attached scale member 27 or the line sensor 26 is always maintained to a constant direction, and the light receiving accuracy at the line sensor 26 can be enhanced.

The material of the cantilever member 29 is quenched stainless steel or quenched iron steel, where quenched steel of SUS 440C is used in First Embodiment. The material of the fixed part 30 is preferably polyphenylsulfide (hereinafter referred to as PPS) containing 40% of glass fiber, for example. The abrasion powder does not produce between the cantilever member 29 and the groove 31 of the fixed part 30 from the movement of the contact 12 according to such a combination, but various abrasion powders easily produce in other combinations, and thus cleaning is required at regular intervals.

Therefore, the abrasion powder does not produce at the groove 31, and long-time use becomes possible without performing maintenance such as internal cleaning even in a case where the cantilever member 29 moves along the groove 31 with the movement of the contact 12 by forming the cantilever member 29 from quenched stainless steel or quenched iron steel, and forming the fixed part 30 from polyphenylsulfide containing glass fiber. The surface hardness of the quenched steel is more preferably greater than or equal to HRC50. This is because the abrasion powder barely produces in a case where the surface hardness is greater than or equal to HRC50.

### Second Embodiment

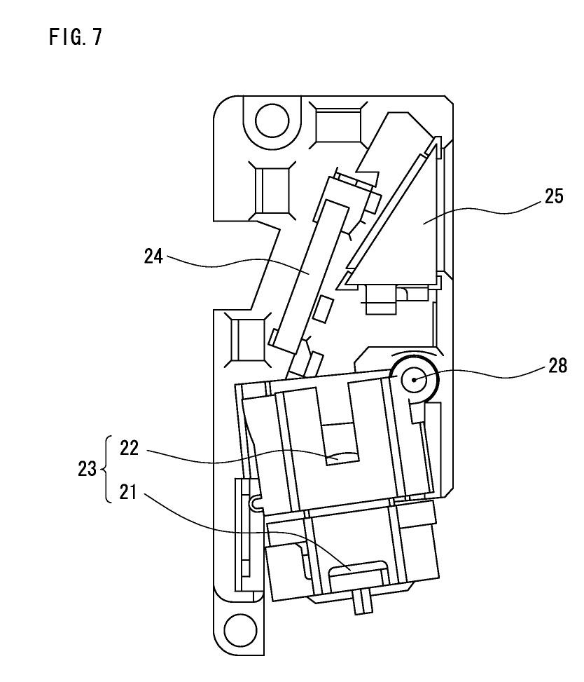

FIG. 7 is a plan view showing an arrangement near the optical mechanism of the contact displacement meter 10 according to Second Embodiment of the present invention. Same reference numerals are denoted for the same components as FIGS. 1 to 3, and the detailed description thereof will be omitted.

As shown in FIG. 7, the light emitting element 21 and the lens 22 are incorporated in an integrated element holder 23 in a substantially square shape, which element holder 23 has a rotational mechanism for rotating with the corner closest to the prism 25 as the center of rotation 28 with respect to the housing 11. Therefore, when the element holder 23 rotates with the center of rotation 28 as the center, the position, and the like of the light exit from the prism 25 can be finely tuned.

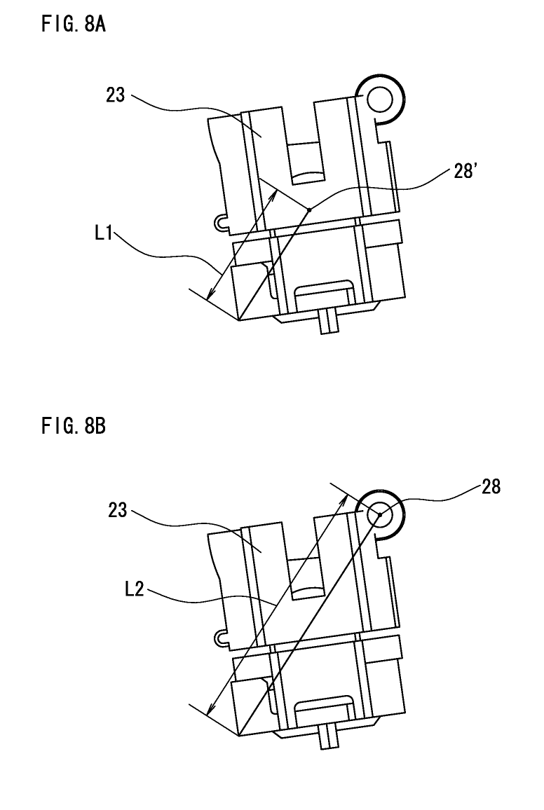

FIGS. 8A and 8B are schematic views for comparing the rotational moment of the element holder 23. FIG. 8A shows a case where an intersection 28′ of the diagonal lines, which is substantially the center position of the element holder, is the center of rotation as in the prior art, and FIG. 8B shows a case where the corner closest to the prism 25 is the center of rotation 28 with respect to the housing 11 as in Second Embodiment.

The angle adjustment of the element holder 23 is carried out by using a thin plate material for the angle adjustment member and interposing the thin plate material between the element holder 23 and a small projection on the left side of the element holder. The turning radius differs by the difference in the position of the center of rotation between FIGS. 8A and 8B, where the angle that changes every time one thin plate material is interposed reduces, and the angle adjustment of the element holder 23 can be finely performed in FIG. 8B in which the turning radius L2 is about twice the turning radius L1. The change in angle involved in the change in the interposing number of thin plate material can be fined by increasing the turning radius to the interposing position of the thin plate material.

Therefore, according to Second Embodiment, the element holder 23 can rotate with the corner closest to the prism 25 as the center of rotation 28, whereby the turning radius becomes larger than when the central part of the element holder 23 is the center of rotation and the adjustment angle of a case where the angle adjustment thin plate material is interposed is reduced, and the angle adjustment of the element holder 23 can be more precisely carried out. Therefore, the slight optical path adjustment can be performed to maintain high light receiving accuracy even when miniaturized, and the displacement can be measured at adequate accuracy. It should be recognized that similar effects can be obtained even in a case where the center of rotation is provided at the corner different from the corner closest to the prism 25 of the two corners positioned in the light exit direction of the element holder 23.

Since the prism 25 is used as the optical mechanism, reflected light, scattered light, and the like of the incident light generate at the surface on the incident side of the prism 25. In a case where such reflected light, scattered light, and the like are left as it is, the reflected light, the scattered light, and the like repeat reflection by the peripheral components, and may again enter the prism 25. Due to the presence of the re-entered light, interference of light, and the like occurs, and thus the possibility that the displacement may be mistakenly measured still remains.

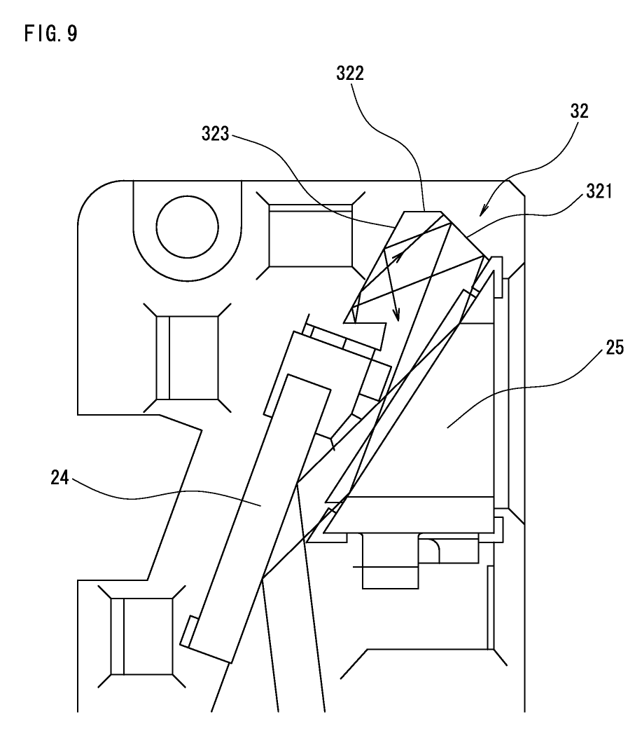

In the contact displacement meter 10 according to Second Embodiment, therefore, a void wall forming a space (void) for converging the reflected light is arranged towards the surface on the incident side of the prism 25. FIG. 9 is a plan view showing the shape of the void wall arranged in the vicinity of the prism 25 of the contact displacement meter 10 according to Second Embodiment of the present invention.

As shown in FIG. 9, the incident light to the prism 25 is reflected, scattered, and the like at the surface of the prism 25, and guided to the void wall 32. The angle of the wall surface of the void wall 32 is set such that the light guided to the void wall 32 repeats reflection for plural times between the void walls 32.

Regarding the light guided to the void wall 32, the intensity is attenuated from the repeated reflection of plural times between the void walls 32, and even in a case where the light leaks to the prism 25 side, the reflected light intensity that causes interference with the converted and output wide-width parallel light cannot be maintained. Therefore, with the arrangement of the void wall 32 having a shape of reflecting the light reflected and scattered at the surface on the incident side of the prism 25 in the direction different from the prism 25, the extent the light reflected and scattered at the surface on the incident side of the prism 25 re-enters the prism 25 is reduced, and interference and the like by the scattered light is less likely to occur.

For instance, in FIG. 9, the angle of the wall portion is adjusted so that all the reflected light of the light entering the surface of the prism 25 is guided to a first wall portion 321 of the void wall 32, and then guided to a second wall portion 322, a third wall portion 323, etc. by the reflection at the first wall portion 321, and does not the re-enter the surface on the incident side of the prism 25 as directly reflected light. That is, the reflected light of the prism 25 is first guided so as to be reflected at any position of the first wall portion 321, where the attachment angle of the first wall portion 321 is set so as to be an angle at which the reflected light by the first wall portion 321 is guided to any position of the second wall portion 322 and any position of the third wall portion 323. Therefore, the displacement is prevented in advance from being mistakenly measured by the line sensor 26, and the displacement can be measured at adequate accuracy. The shape of the void wall 32 is not limited to the shape shown in FIG. 9, and similar effects can be expected as long as the shape is such that the light reflected at the incident surface of the prism 25 is prevented from directly re-entering the prism 25.

### Third Embodiment

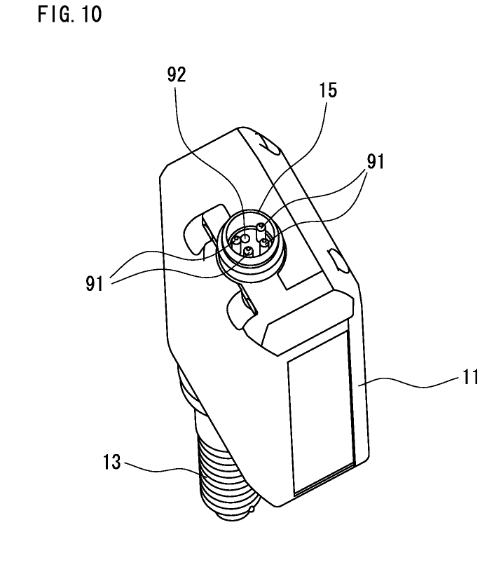

FIG. 10 is a perspective view including the connector portion 15 of the contact displacement meter 10 according to Third Embodiment of the present invention. The housing 11 of the contact displacement meter 10 is normally sealed such that air inside does not leak outside. In particular, the accordion cover 13 is arranged to obtain an air-tight state to support a smooth movement with respect to the inserting portion of the moving contact 12. Therefore, in a case where the contact 12 moves, the air inside the housing 11 acts as a resistance and an accurate displacement may not be measured.

As shown in FIG. 10, a hole 92 passed through into the housing 11 is formed in the connector portion 15 connected with the external wiring in addition to a plurality of connection pins 91, 91, . . . for connection. When the contact 12 moves, the air inside the housing 11 is discharged to the outside from the connector portion 15 via the hole 92 or outside air is taken in.

Therefore, with the arrangement of the hole 92 passed through into the housing 11 at the connector portion 15 connected with the external wiring, the air inside the housing 11 is discharged to the outside from the hole 92 when the contact 12 is pushed in, and the outside air is taken into the housing 11 through the hole 92 when the contact 12 is pulled out. Therefore, the air resistance with respect to the movement of the contact 12 is reduced and the displacement can be more accurately measured.

The present invention is not limited to the above examples, and it should be recognized that various modifications, replacements, and the like may be made within the scope of the invention.

What is claimed is:

1. A contact displacement meter comprising:
a light emitting element;
a lens that converts light emitted by the light emitting element to parallel light;
a prism that deflects the parallel light converted by the lens to a predetermined direction, and converts to wide-width parallel light;
a plate-shaped scale member formed with a predetermined pattern including a plurality of reference patterns and unique information on each of the reference patterns in a direction substantially orthogonal to the predetermined direction as a combination of a light passing region for passing light and a light shielding region for shielding light, and arranged in an irradiation range of the converted parallel light;
a linear sensor including a plurality of light receiving elements that are arrayed at substantially equal intervals along the direction substantially orthogonal to the predetermined direction and that receive passed light of the wide-width parallel light converted by the prism irradiated on the scale member;
a housing that accommodates the light emitting element, the lens, the prism, the scale member, and the linear sensor, and that is fixed with one of the scale member and the linear sensor;
a contact that is fixed with another one of the scale member and the linear sensor, and that is attached to be movable in the direction substantially orthogonal to the predetermined direction with respect to the housing; and
a calculation unit that obtains a projection position of the reference pattern on the linear sensor and the unique information on the reference pattern based on a received light signal received by the plurality of light receiving elements in the linear sensor, and that calculates a displacement of the contact based on the projection position and the unique information.

2. The contact displacement meter according to claim 1, wherein
the light emitting element and the lens are incorporated in an integrated element holder in a substantially square shape, and
the element holder has a rotational mechanism that rotates with respect to the housing with a corner closest to the prism as a center of rotation.

3. The contact displacement meter according to claim 1, wherein
the contact is arranged with a cantilever member that extends in a direction substantially parallel to the predetermined direction and has a distal end in a pin shape, and
a fixed part having a long groove along the direction substantially orthogonal to the predetermined direction in which the pin-shaped distal end of the cantilever member is movable is fixed to the housing.

4. The contact displacement meter according to claim 3, wherein the cantilever member is a quenched stainless steel or a quenched iron steel, and the fixed part is polyphenylsulfide including glass fiber.

5. The contact displacement meter according to claim 1, wherein the housing includes a void wall having a shape of reflecting light reflected at an incident surface of the prism out of the parallel light from the lens to a direction in which the light does not re-enter the prism.

6. The contact displacement meter according to claim 1, wherein
the housing is sealed such that air inside does not leak outside,
a connector portion that is connected with an external wiring is arranged, and
the connector portion has a plurality of connection pins, and a hole passed through into the housing so that air enters and exits through the hole.
